(19) United States
(12) Patent Application Publication
(10) Pub. No.: US 2023/0212022 A1
(43) Pub. Date: Jul. 6, 2023

(54) METHOD OF CONVERTING COPPER CYANIDE TO COPPER OXIDE AND SYSTEM THEREOF

(71) Applicant: CYANCO CORPORATION, Sugar Land, TX (US)

(72) Inventors: Pamela MOYO, Sugar Land, TX (US); Steve DIXON, Tucson, AZ (US); Roy NORCROSS, Sugar Land, TX (US)

(21) Appl. No.: 18/075,318

(22) Filed: Dec. 5, 2022

Related U.S. Application Data
(60) Provisional application No. 63/285,532, filed on Dec. 3, 2021.

(51) Int. Cl. C01G 3/02

(52) U.S. Cl. CPC C01G 3/02

(57) ABSTRACT

A method and system for converting copper cyanide to copper oxide is provided. The method includes contacting a copper cyanide solution with an acidic solution in a precipitation tank under reaction conditions sufficient to produce a copper cyanide slurry, removing the copper cyanide slurry from the precipitation tank, separating solid copper cyanide from the copper cyanide slurry in a first separation device, removing the solid copper cyanide from the first separation device, contacting the solid copper cyanide with a sodium hydroxide solution in a production tank under reaction conditions sufficient to produce a copper oxide slurry, removing the copper oxide slurry from the production tank, separating solid copper oxide from the copper oxide slurry in a second separation device, and removing from the second separation device any residual sodium hydroxide not reacted during the process of contacting the solid copper cyanide with the sodium hydroxide solution in the production tank.

### CROSS-REFERENCE TO RELATED APPLICATIONS

This application claims priority to U.S. Provisional Application No. 63/285,532, filed Dec. 3, 2021, which is incorporated herein by reference.

### TECHNICAL FIELD OF THE INVENTION

This disclosure relates to an improved method and system for converting copper cyanide to copper oxide.

### BACKGROUND OF THE INVENTION

Leaching gold ore with cyanide is a well-established, robust, and cost-effective process. The presence of other minerals in a gold ore can complicate the process and render the process of leaching gold with cyanide less cost effective for mines. Most copper minerals have a good solubility in cyanide solutions (Leaver & Woolf, 1931). When copper minerals are present in the gold ore, they will co-leach together with gold. This poses gold recovery issues and increases the consumption of cyanide. Copper cyanides can load on activated carbon, which impacts gold recovery. To address the issue, most operating sites simply increase their cyanide levels, resulting in higher operating costs.

Several studies (Dai, Simon & Breuer, 2012) have been conducted with the intent of developing a cost-effective method to minimize the impact of copper in gold recovery. Some methods explored the recovery of both copper and cyanide to improve economics. SART (sulfidization-acidification-recycling-thickening) and AVR (acidification-volatilization-re-neutralization) are two such processes that are well-known and have been applied industrially (Botz & Acar, 2007 and Lopez-Pacheco, 2016). With these processes, the copper is recovered by precipitation while cyanide is recovered by capturing the hydrogen cyanide (HCN) gas during the acidification of the cyanide solutions that contain copper.

The SART and AVR processes are effective for clear solutions. However, they pose a challenge for slurry systems, like carbon-in-leach (CIL) or carbon-in-pulp (CIP), as they require capital intensive solid-liquid separation equipment. Additionally, in most commercial operations, the copper concentration is normally low in effluents, making the recovery processes less economic.

Gold leaching with cyanide is normally carried out at pH 10.5-11. At these pH levels, the copper that co-leaches with gold is mostly present as copper tricyanide complex. The adsorption efficiency of this copper complex on activated carbon is low. This low adsorption means that copper will continue to build up in the circuit as the process water recirculates.

Many studies have addressed this issue including Sceresini 1991, who patented a process that utilized a lean cyanide concentration pre-CIL to selectively recover copper on activated carbon prior to recovering precious metals. The copper-loaded carbon was then cold stripped to produce a high-grade copper cyanide solution, which was subsequently acidified, thereby producing a copper cyanide precipitate and HCN gas. The HCN gas would be recovered and neutralized, while the copper cyanide would be boiled in sulfuric acid to produce copper sulfate.

More recently, Dixon 2017 proposed a process to address the same issue using continuous elution of activated carbon to selectively remove copper from the circuit. The copper containing eluant is then sent to the Merrill Crowe circuit to recover the precious metals before the copper is precipitated as copper cyanide (CuCN).

There is, however, a need in the art for a more efficient and cost-effective process for converting copper cyanide to copper oxide.

### SUMMARY OF THE INVENTION

The invention relates to a method for converting copper cyanide to copper oxide, comprising the steps of:

contacting a copper cyanide solution with an acidic solution in a precipitation tank under reaction conditions sufficient to produce a copper cyanide slurry;

removing the copper cyanide slurry from the precipitation tank;

optionally, removing a gaseous effluent created in the precipitation tank;

separating solid copper cyanide from the copper cyanide slurry in a first separation device;

removing the solid copper cyanide from the first separation device;

optionally, removing a liquid effluent created in the first separation device;

contacting the solid copper cyanide with a sodium hydroxide solution in a production tank under reaction conditions sufficient to produce a copper oxide slurry;

removing the copper oxide slurry from the production tank;

separating solid copper oxide from the copper oxide slurry in a second separation device;

optionally, removing the solid copper oxide from the second separation device; and

optionally, removing from the second separation device any residual sodium hydroxide not reacted during the process of contacting the solid copper cyanide with the sodium hydroxide solution in the production tank.

The invention also relates to a system for converting copper cyanide to copper oxide comprising:

a precipitation tank for contacting a copper cyanide solution with an acidic solution to produce a copper cyanide slurry;

optionally, the precipitation tank has a first output port for discharging the copper cyanide slurry;

optionally, the precipitation tank has a second output port for discharging a gaseous effluent created in the precipitation tank;

a first separation device for receiving the copper cyanide slurry and separating solid copper cyanide from the copper cyanide slurry;

optionally, the first separation device has a third output port for discharging the solid copper cyanide;

optionally, the first separation device has a fourth output port for discharging a liquid effluent created in the first separation device;

a production tank for receiving the solid copper cyanide and contacting the solid copper cyanide with a sodium hydroxide solution to produce a copper oxide slurry;

optionally, the production tank has a fifth output port for discharging the copper oxide slurry;

a second separation device for receiving the copper oxide slurry and separating solid copper oxide from the copper oxide slurry;

optionally, the second separation device has a sixth output port for discharging the solid copper oxide; and

optionally, the second separation device has a seventh output port for discharging any residual sodium hydroxide not reacted during the process of converting the solid copper cyanide to the copper oxide slurry in the production tank.

The invention allows for more handling options as the recovered copper oxide can be a) easily transported to a smelter with minimal restrictions (as compared to the transport of copper cyanide), and b) be processed on site to produce copper cathodes. The process of the invention can be easily adapted to most brownfield operations with minimal new equipment and reagents required.

In addition, the invention minimizes the risks associated with transporting copper cyanide, reduces the environmental impact, and increases manufacturing efficiencies by allowing copper cathodes to be produced in the same plant in which the extraction process is performed.

### BRIEF DESCRIPTION OF THE FIGURES

FIG. 1 shows an exemplary system for carrying out the inventive method for converting copper cyanide to copper oxide.

FIG. 2 shows the impact of initial NaOH:CuCN ratio on copper grade in product.

FIG. 3 shows the impact initial NaOH:CuCN ratio on NaOH consumed.

FIG. 4 shows the relationship between residual NaOH and copper grades in solid product.

FIG. 5 shows the relationship between residual NaOH and copper grades in filtrate.

FIG. 6 shows the consumption of NaOH vs copper grade in the product.

### DETAILED DESCRIPTION OF THE INVENTION

The invention relates to a method for converting copper cyanide to copper oxide, comprising the steps of:

contacting a copper cyanide solution with an acidic solution in a precipitation tank under reaction conditions sufficient to produce a copper cyanide slurry;

removing the copper cyanide slurry from the precipitation tank;

optionally, removing a gaseous effluent created in the precipitation tank;

separating solid copper cyanide from the copper cyanide slurry in a first separation device;

removing the solid copper cyanide from the first separation device;

optionally, removing a liquid effluent created in the first separation device;

contacting the solid copper cyanide with a sodium hydroxide solution in a production tank under reaction conditions sufficient to produce a copper oxide slurry;

removing the copper oxide slurry from the production tank;

separating solid copper oxide from the copper oxide slurry in a second separation device;

optionally, removing the solid copper oxide from the second separation device; and

optionally, removing from the second separation device any residual sodium hydroxide not reacted during the process of contacting the solid copper cyanide with the sodium hydroxide solution in the production tank.

The acidic solution may be selected from the group consisting of sulfuric acid, nitric acid, and hydrochloride acid.

The method of the invention may further comprise receiving the copper cyanide solution in the precipitation tank from an elution vessel. An activated carbon comprising copper with a solution of sodium hydroxide and sodium cyanide may be contacted in the elution vessel to produce an eluate comprising the copper cyanide solution. The activated carbon comprising copper may further comprise gold and/or silver. The sodium hydroxide and sodium cyanide may be at a pH ranging from about 11-12 and at a temperature ranging from about 0-60° C. The solution of sodium hydroxide and sodium cyanide in the elution vessel may be received from a recycle solution tank.

The method of the invention may further comprise receiving the gaseous effluent created in the precipitation tank in a gas scrubber. The gaseous effluent may be hydrogen cyanide gas. The hydrogen cyanide gas in the gas scrubber may be contacted with a sodium hydroxide solution to produce a sodium cyanide solution. The sodium cyanide solution may be removed from the gas scrubber.

The method of the invention may further comprise, optionally, contacting the solid copper cyanide with water in the production tank. The solid copper cyanide may be contacted with the sodium hydroxide solution in the production tank at ambient temperature and may further comprise, optionally, air sparging in the production tank. The mole ratio of NaOH:CuCN in the production tank may range from 2 to 0.1 (e.g., 1.9, 1.8, 1.7, 1.6, 1.5, 1.4, 1.3, 1.2, 1.1, 1, 0.9, 0.8, 0.7, 0.6, 0.5, 0.4, 0.3, 0.2), preferably 0.84 or greater. The percent solids as CuCN may range from 5% to 50% (e.g., 10%, 15%, 20%, 25%, 30%, 35%, 40%, 45%). The dosage rate of NaOH in the production tank may be at least 0.265 kg (e.g., at least 0.295 kg) NaOH per kg of copper.

The copper oxide slurry may comprise copper(I) oxide and/or copper(II) oxide. 70% or greater (e.g., 75%, 80%, 85%, 90%) copper may be recovered in the copper oxide.

Any residual sodium hydroxide present in the second separation device may be recycled back to the recycle solution tank, the gas scrubber, the production tank, or any combination thereof.

The invention also relates to a system for practicing the method of the invention. For example, the invention relates to a system for converting copper cyanide to copper oxide comprising:

a precipitation tank for contacting a copper cyanide solution with an acidic solution to produce a copper cyanide slurry;

optionally, the precipitation tank has a first output port for discharging the copper cyanide slurry;

optionally, the precipitation tank has a second output port for discharging a gaseous effluent created in the precipitation tank;

a first separation device for receiving the copper cyanide slurry and separating solid copper cyanide from the copper cyanide slurry;

optionally, the first separation device has a third output port for discharging the solid copper cyanide;

optionally, the first separation device has a fourth output port for discharging a liquid effluent created in the first separation device;

a production tank for receiving the solid copper cyanide and contacting the solid copper cyanide with a sodium hydroxide solution to produce a copper oxide slurry;

optionally, the production tank has a fifth output port for discharging the copper oxide slurry;

a second separation device for receiving the copper oxide slurry and separating solid copper oxide from the copper oxide slurry;

optionally, the second separation device has a sixth output port for discharging the solid copper oxide; and

optionally, the second separation device has a seventh output port for discharging any residual sodium hydroxide not reacted during the process of converting the solid copper cyanide to the copper oxide slurry in the production tank.

The acidic solution may be selected from the group consisting of sulfuric acid, nitric acid, and hydrochloride acid.

The precipitation tank may include a first input port for receiving the copper cyanide solution and a second input port for receiving the acidic solution. The first input port for receiving the copper cyanide solution may be connected to an elution vessel. The elution vessel may include a solid input port for receiving an activated carbon comprising copper and a liquid input port for receiving a solution of sodium hydroxide and sodium cyanide. The activated carbon comprising copper may further comprise gold and/or silver. The activated carbon comprising copper may be contacted with the solution of sodium hydroxide and sodium cyanide to produce an eluate comprising the copper cyanide solution. The solution of sodium hydroxide and sodium cyanide may be at a pH ranging from about 11-12 and at a temperature ranging from about 0-60° C.

As used herein, the term “port” means any opening for intake or release of a solid and/or fluid.

The liquid input port for receiving the solution of sodium hydroxide and sodium cyanide may be connected to a recycle solution tank containing the solution of sodium hydroxide and sodium cyanide.

The second output port of the precipitation tank may be connected to a gas scrubber for receiving the gaseous effluent created in the precipitation tank. The gaseous effluent may be hydrogen cyanide gas. The hydrogen cyanide gas in the gas scrubber may be contacted with a sodium hydroxide solution to produce a sodium cyanide solution. The gas scrubber may include a liquid input port for receiving the sodium hydroxide solution and a liquid output port for removing the sodium cyanide solution.

The production tank for receiving the solid copper cyanide may include a first liquid input port for receiving the sodium hydroxide solution and, optionally, a second liquid input port for receiving water. The solid copper cyanide is contacted with the sodium hydroxide solution in the production tank at ambient temperature and may further comprise, optionally, air sparging in the production tank. The mole ratio of NaOH:CuCN in the production tank may range from 2 to 0.1 (e.g., 1.9, 1.8, 1.7, 1.6, 1.5, 1.4, 1.3, 1.2, 1.1, 1, 0.9, 0.8, 0.7, 0.6, 0.5, 0.4, 0.3, 0.2), preferably 0.84 or greater. The percent solids as CuCN ranges from 5% to 50% (e.g., 10%, 15%, 20%, 25%, 30%, 35%, 40%, 45%). The dosage rate of NaOH in the production tank is at least 0.265 kg (e.g., at least 0.295 kg) NaOH per kg of copper.

The copper oxide slurry may comprise copper(I) oxide and/or copper(II) oxide. 70% or greater (e.g., 75%, 80%, 85%, 90%) copper may be recovered in the copper oxide.

Any residual sodium hydroxide present in the second separation device may be recycled back to the recycle solution tank, the gas scrubber, the production tank, or any combination thereof.

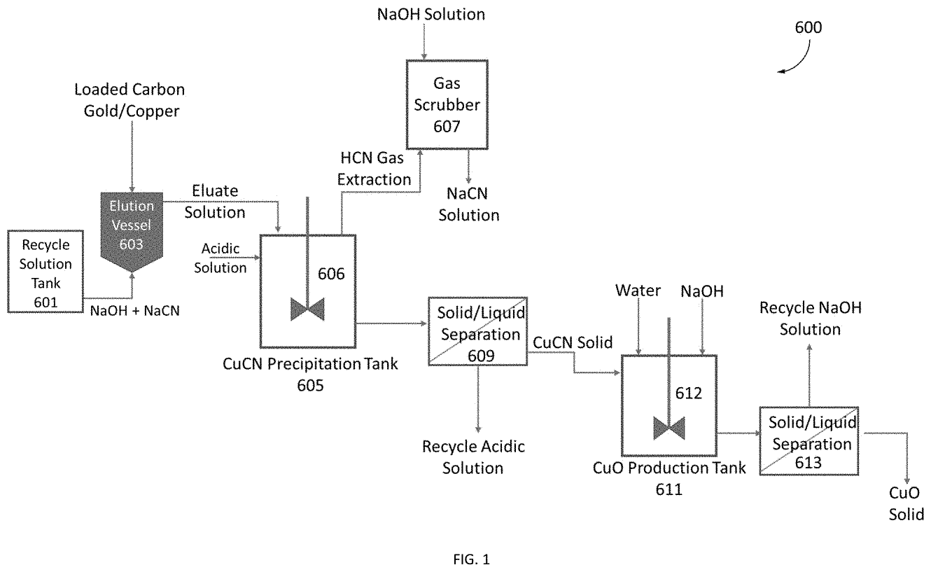

FIG. 1 shows a schematic depiction of an exemplary system for carrying out a method for extracting a CuO solid from CuCN produced during the elution of gold from an activated carbon loaded with gold and copper. Besides or in addition to gold, the activated carbon may contain other metals, such as silver, and materials. Furthermore, process equipment not central to the discussion have been omitted. Thus, it is understood to one skilled in the art that pumps, heat exchangers, and tanks not shown in FIG. 1 may be necessary.

System 600 includes a recycle solution tank 601, an elution vessel 603, a CuCN precipitation tank 605, a gas scrubber 607, a first solid/liquid separation vessel 609, a CuO production tank 611, and a second solid/liquid separation vessel 613.

Activated carbon comprising gold and copper, which is generated from a conventional carbon adsorption process, is loaded into the elution vessel 603. While not shown in FIG. 1, as discussed above, the activated carbon may comprise other metals, such as silver, and/or materials, besides or in addition to gold. The recycle tank 601 is connected with the elution vessel 603. The sodium hydroxide and sodium cyanide solution (NaOH+NaCN) is pumped into the bottom of the elution vessel 603 such that the NaOH+NaCN solution passes through the activated carbon present in the elution vessel 603.

The NaOH+NaCN solution present in the elution vessel 603 may have a high pH (e.g., about 11-12) and is heated prior to and/or after it is introduced into the elution vessel. As the NaOH+NaCN solution contacts the activated carbon in the elution vessel, a copper cyanide solution is created, especially at lower temperatures (e.g., 0-60° C.). The copper cyanide solution may be a copper cyanide complex solution. The copper cyanide complex solution may include, for example, dicyanide, tricyanide, and tetracyanide complexes, or combinations thereof.

The eluate solution produced in the elution vessel 603, which contains the copper cyanide solution, is added into the CuCN precipitation tank 605. The eluate solution may be added directly to the CuCN precipitation tank 605 or the eluate solution may be provided to a storage tank (not illustrated) and the eluate solution may be dynamically added from the storage tank to the CuCN precipitation tank 605.

In an exemplary embodiment, gold can be extracted from the eluate solution before the eluate solution is provided to the CuCN precipitation tank 605. That is, besides the copper cyanide complexes, gold may be included in the eluate solution from the elution vessel 603 particularly when the solution is within a temperature range below 100-120° C. When gold is included in the eluate stream provided from the elution vessel 103, a separate process can be performed where the stream may be diverted to capture the gold prior to the solution being added to the CuCN precipitation tank 605.

For example, while not illustrated, a switch may be provided between an outlet of the elution vessel 103 and the CuCN precipitation tank 605 such that the switch is articulated based on whether gold is being extracted or separated from the stream output from the elution vessel 103.

In the CuCN precipitation tank 605, an acidic solution is added to the eluate solution and the combined solution is agitated using stirrer or mixer 606. The acidic solution may be any acid having the desired pH levels, such as sulfuric acid, nitric acid, or hydrochloric acid. In an exemplary embodiment, the acidic solution has a pH of 2-3 to achieve a maximum CuCN precipitation without overusing the acidic solution.

The CuCN precipitation tank 605 can include a gas extraction system to extract hydrocyanide (HCN) gas generated in the CuCN precipitation tank 605 to the gas scrubber 607. That is, the eluate solution is coming into the CuCN precipitation tank 605 at a high pH and the acidic solution is added to drop the pH. As the pH lowers in the CuCN precipitation tank 605, a HCN gas is generated.

After the HCN gas is extracted to gas scrubber 607, a NaOH solution can be added to the extracted HCN gas in the gas scrubber 607 to create a NaCN solution. This NaCN solution can be reused or recycled in various processes.

The solution that remains within the CuCN precipitation tank 605 after the HCN gas is extracted, is a slurry. This slurry is then output from the CuCN precipitation tank 605 to the first solid/liquid separation tank 609. For example, the first solid/liquid separation tank 609 may be a filter that filters out CuCN solids from the remaining solution. The solids may be input into the CuO production tank 611 and the remaining solution having a lower pH may be removed from the first solid/liquid separation tank 609 and recycled throughout the process. The solution may have a low pH and can be returned to the CuCN precipitation tank 605. The amount of solution used in the CuCN precipitation tank 605 may be less than the main process solution, so the acidic solution can be easily neutralized and recycled back into the process.

After the CuCN solids are introduced to the CuO production tank 611, water and NaOH are added to the CuO production tank 611. That is, the CuO can be repulped with water and that solution may be agitated using agitator or mixer 612. Then NaOH is added to the CuO production tank 611 and the resulting solution is agitated for about an hour.

The solution output from the CuO production tank 611 is then input into the second solid/liquid separation tank 613 to filter out CuO solid from the solution. The filtered solution can be recycled back to the recycle solution tank 601, the gas scrubber 607, the CuO production tank 611, or any other process that uses a similar solution, such that the solution is reused.

### Examples

The conversion of cuprous cyanide (CuCN) to copper oxide was explored by varying the percent solids as CuCN and the mole ratio of sodium hydroxide (NaOH) to CuCN at ambient temperatures. Analytical grade copper cyanide and sodium hydroxide and a reaction time of 1 hour were used. The variation of temperature, pH, and oxidation reduction potential (ORP) of slurry were monitored after addition of NaOH. A total of 11 tests were conducted at ambient conditions. The slurry from each test was filtered at the end of the reaction. The filtrate was assayed for copper, total cyanide, weak acid dissociable (WAD) cyanide, alkalinity (as gram per liter sodium hydroxide), and pH. The filtered solids were assayed for copper. Table 1 summarizes the parameters that were explored.

TABLE 1
Test Conditions for Conversion of CuCN to CuO

| | Mole Ratio | % Solids | | |
|---|---|---|---|---|
| Test# | NaOH:CuCN | as CuCN | NaOH (g) | CuCN (g) |
| 1 | 1.12 | 10% | 5.01 | 10.02 |
| 2 | 0.56 | 20% | 5.01 | 20.02 |
| 3 | 1.68 | 10% | 7.51 | 10.01 |
| 4 | 0.84 | 20% | 7.51 | 20.01 |
| 5 | 1.12 | 20% | 10.01 | 20.01 |
| 6 | 0.75 | 30% | 10.01 | 30.01 |
| 7 | 0.45 | 20% | 4.05 | 20.02 |
| 8* | 0.56 | 20% | 5.02 | 20.02 |
| 9 | 0.56 | 25% | 6.26 | 25.02 |
| 10 | 1.12 | 25% | 12.51 | 25.02 |
| 11 | 0.56 | 30% | 7.51 | 30.02 |

*Air sparging at ambient temperatures

The focus of the work was to define the optimum and highest-percent solids and concentration of copper in solution. The conversion of CuCN to different copper oxides was based on the following:

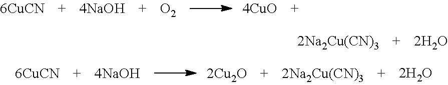

Results and Discussion

Table 2 compares the copper recovery and copper grade in the converted product. The converted product ranged in color from black to brownish black to greenish yellow, indicating that a range of copper compounds were present. The copper grade in the product ranges from 78-89%, confirming that there were several copper compounds present. The theoretical grade of copper in cupric oxide (CuO) is 79.9% and cuprous oxide (Cu₂O) is 88.8%.

TABLE 2
Grade and Recovery of the Product

| | Mole Ratio | % Solids as | % Cu in | % Cu Recovered |
|---|---|---|---|---|
| Test# | NaOH:CuCN | CuCN | Product | in Product |
| 1 | 1.12 | 10% | 88.6% | 76% |
| 2 | 0.56 | 20% | 83.1% | 77% |
| 3 | 1.68 | 10% | 89.2% | 75% |
| 4 | 0.84 | 20% | 89.4% | 76% |
| 5 | 1.12 | 20% | 87.5% | 75% |
| 6 | 0.75 | 30% | 81.0% | 81% |
| 7 | 0.45 | 20% | 78.6% | 80% |
| 9 | 0.56 | 25% | 81.8% | 73% |
| 10 | 1.12 | 25% | 86.6% | 75% |
| 11 | 0.56 | 30% | 77.5% | 81% |

The highest copper grade of 89.4% was achieved at 20% solids and an initial NaOH:CuCN mole ratio of 0.84. The corresponding copper recovery in the product was 76%. This indicates that the initial CuCN is converted to Cu₂O at mole ratios of 0.84 and higher. The highest recovery of 81% is attained at 30% solids. The mole ratio of 0.75 produces a much higher copper grade in the product compared to a ratio of 0.56. The only setback observed with 30% solids and mole ratio of 0.75 was the slurry was too viscous, resulting in poor agitation.

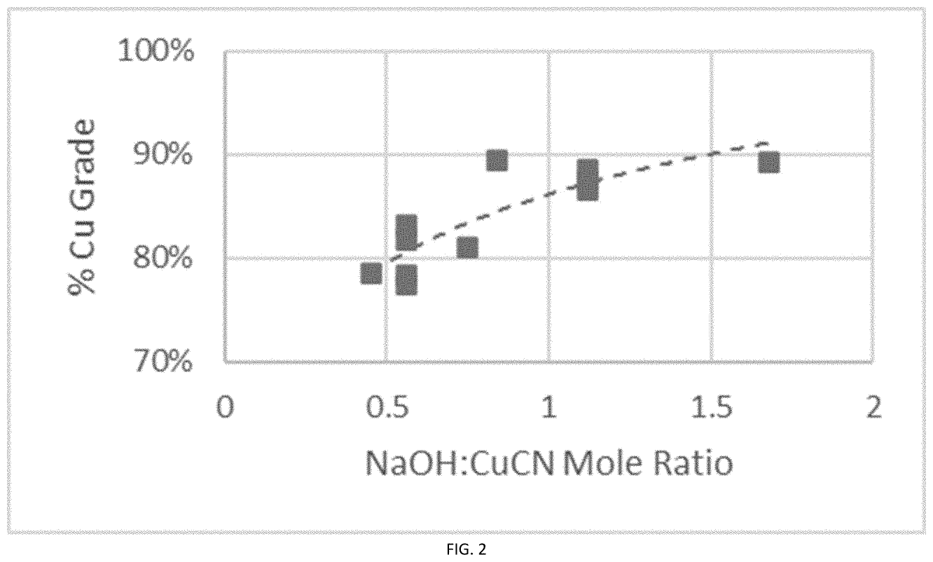

FIG. 2 shows the impact on the initial NaOH:CuCN mole ratio on the copper grade in the product. Mole ratios less than 0.84 produced a copper grade averaging approximately 80%, while mole ratios greater than 0.84 had copper grades closer to 88%. This implies that a lower mole ratio produces CuO while a higher ratio produces Cu₂O.

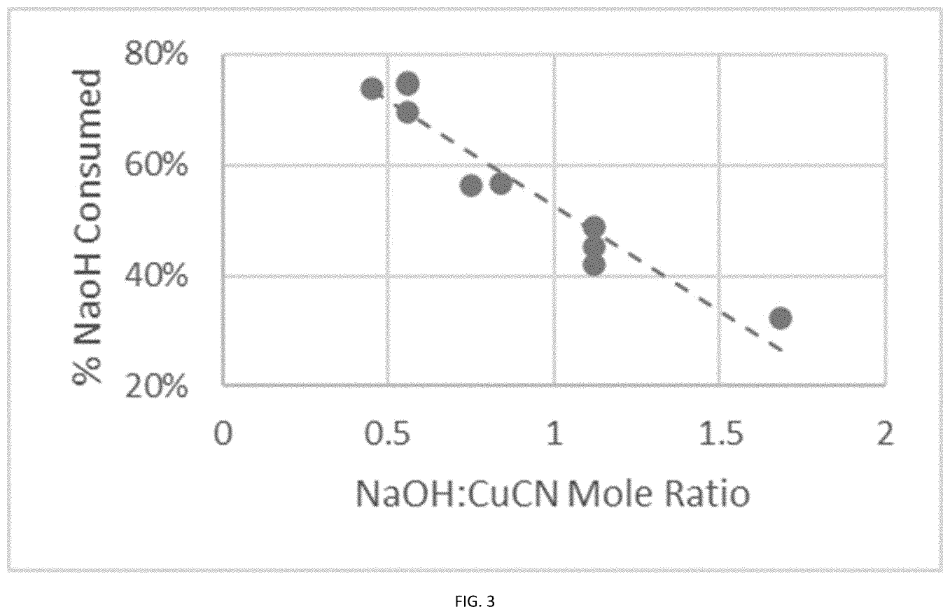

The initial NaOH:CuCN mole ratio also influenced the amount of NaOH consumed, as shown in FIG. 3. The higher the mole ratio, the less NaOH was consumed. Less than 50% NaOH is consumed for mole ratios greater than 0.84. The mole ratios that produce the highest copper grade also consume less NaOH during the process. Any remaining NaOH not consumed during the reaction can be recycled back to the CuCN conversion circuit or elution circuit.

To support the back calculated assays using solution assays, filtered solids were submitted for XRD. See Table 3. XRD showed that Test 4, which had the highest Cu grade, also had the highest amount of CuO at 76%. The highest CuO was attained with heating and air sparging conditions with a CuO grade of 78%. But the heating and air sparging improved the conversion by only 2%. It is possible that the additional 2% gain would not be economical beneficial compared to non-heating options.

TABLE 3
XRD Results

| | | % | NaOH: | Mineral Phases | | |
|---|---|---|---|---|---|---|
| Test | | Solids as | CuCN | | Cu(OH) | Cu(CN) |
| # | Conditions | CuCN | Ratio | CuO % | 2% | 2% |
| 1 | Normal | 10% | 1.12 | 64 | 2 | 34 |
| 2 | Normal | 20% | 0.56 | 58 | 0 | 42 |
| 3 | Normal | 10% | 1.68 | 61 | 2 | 37 |
| 4 | Normal | 20% | 0.84 | 76 | 2 | 22 |
| 5 | Normal | 20% | 1.12 | 72 | 2 | 26 |
| 6 | Normal | 30% | 0.75 | 53 | 1 | 46 |
| 7 | Normal | 20% | 0.45 | 60 | 1 | 39 |
| 8 | Air | 20% | 0.56 | 59 | 0 | 41 |
| | sparging | | | | | |
| 9 | Normal | 25% | 0.56 | 68 | 1 | 31 |
| 10 | Normal | 25% | 1.12 | 67 | 1 | 32 |
| 11 | Normal | 30% | 0.56 | 52 | 1 | 47 |
| 12 | Heating | 20% | 0.56 | 72 | 0 | 28 |
| | 40-50° C. | | | | | |
| 13 | Heat + Air | 20% | 0.56 | 78 | 1 | 21 |
| | sparging | | | | | |

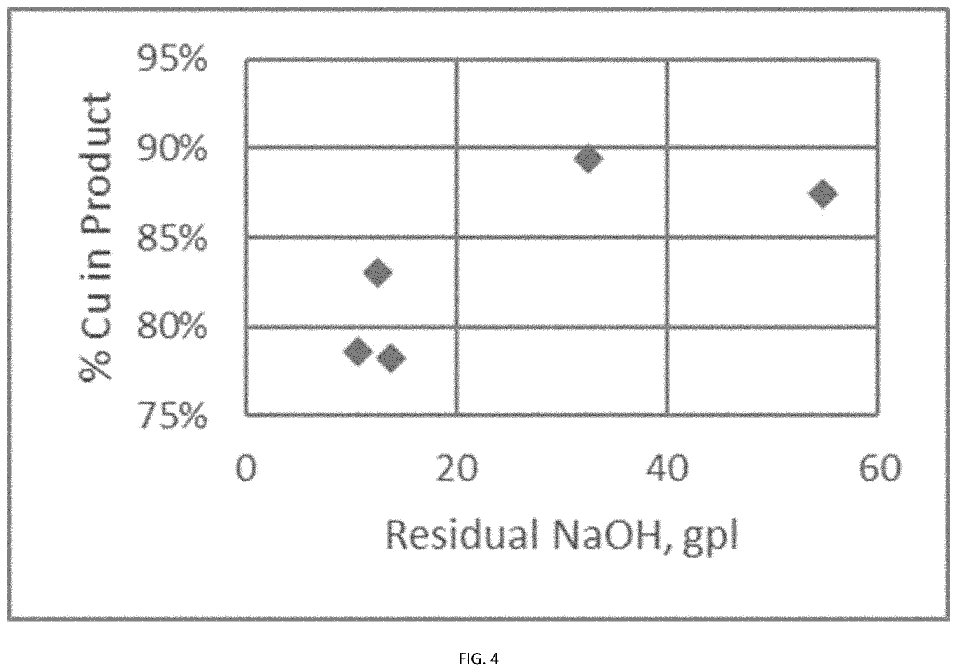

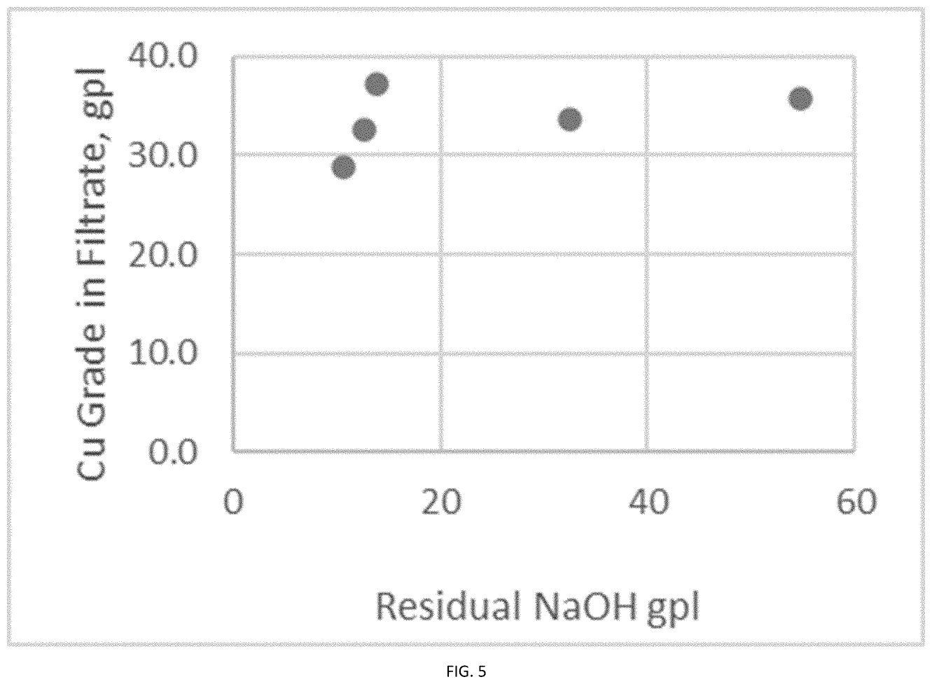

The 20% solids conditions were used to further understand the residual NaOH in grams per liter (gpl) with copper grade in the solid product. FIG. 4 shows the variation of residual grams per liter NaOH with the solids copper grade. A residual 20 gpl NaOH is required to produce CuO. The percent copper in the filtrate was found to be independent of the residual NaOH as shown in FIG. 5. Approximately 25% of the copper in the feed was recovered in the filtrate for all conditions tested.

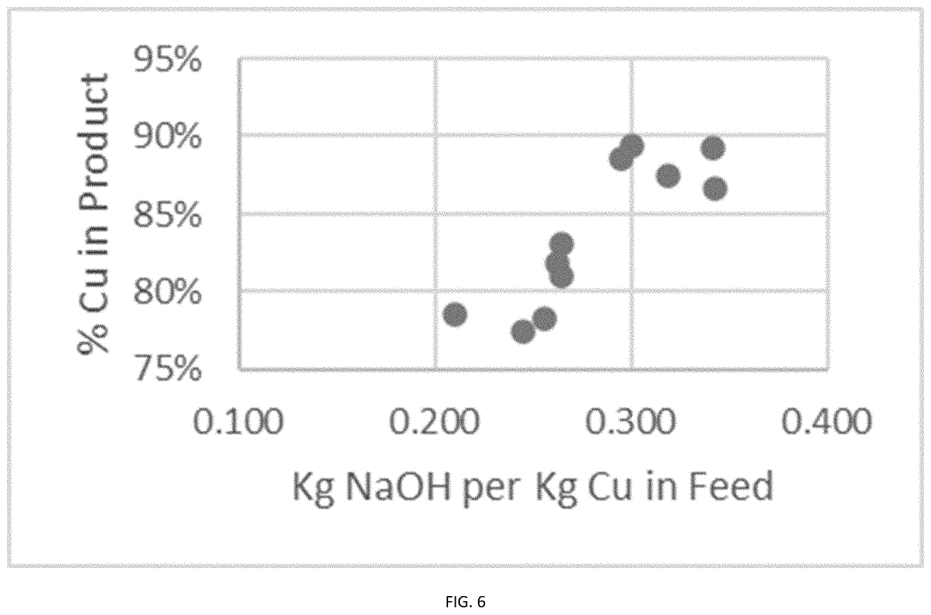

FIG. 6 shows the relationship between NaOH consumption (kg NaOH per kg copper in feed) and the copper grade in the product. A copper product of greater than 88% Cu (cuprous oxide) can be produced with a sodium hydroxide consumption of 0.295 kg per kilograms of copper in the feed. This is equivalent to 21 grams per liter (gpl) NaOH at 10% solids.

The lower % solids result in lower NaOH consumption for NaOH:CuCN mole ratios greater than 0.6. Thus, a compromise will have to be made between capital and operating costs. A higher percent solid optimizes capital costs while lower percent solids will optimize operating costs. A NaOH consumption of 0.265 kg per kg of copper in the feed results in a product with about 80% copper (cupric oxide). A lower-grade copper oxide product can be produced to optimize both recovery and operating costs.

### CONCLUSION

The conversion of CuCN to CuO can be accomplished using NaOH at ambient temperatures. The following conclusions were drawn:

The highest copper grade for the solid product was attained at NaOH:CuCN mole ratios of 0.84 and greater.

Approximately 25% of the copper in the feed was recovered in the filtrate.

30% solids produced the highest level of copper recovery, however, the slurry was too viscous.

A minimum required consumption rate of 0.265 kg NaOH per kg of copper was required to make cupric oxide. Cuprous oxide required a higher NaOH dosage rate of 0.295 kg per kg of copper in the feed.

A lower percent solids will optimize operating costs as it translates to low NaOH consumption, while a higher percent solids will optimize capital costs.

The higher NaOH:CuCN mole ratios resulted in lower NaOH consumption. This means that the filtrate can recycled back either to CuCN conversion circuit or to the elution circuit.

The process of converting copper cyanide to cupric oxide provides a more viable option for shipping and processing, making this process advantageous from an economical and environmental viewpoint.

### Exemplary Embodiments

E1. A method for converting copper cyanide to copper oxide, comprising the steps of:

contacting a copper cyanide solution with an acidic solution in a precipitation tank under reaction conditions sufficient to produce a copper cyanide slurry;

removing the copper cyanide slurry from the precipitation tank;

optionally, removing a gaseous effluent created in the precipitation tank;

separating solid copper cyanide from the copper cyanide slurry in a first separation device;

removing the solid copper cyanide from the first separation device;

optionally, removing a liquid effluent created in the first separation device;

contacting the solid copper cyanide with a sodium hydroxide solution in a production tank under reaction conditions sufficient to produce a copper oxide slurry;

removing the copper oxide slurry from the production tank;

separating solid copper oxide from the copper oxide slurry in a second separation device;

optionally, removing the solid copper oxide from the second separation device; and

optionally, removing from the second separation device any residual sodium hydroxide not reacted during the process of contacting the solid copper cyanide with the sodium hydroxide solution in the production tank.

E2. The method of E1, wherein the acidic solution is selected from the group consisting of sulfuric acid, nitric acid, and hydrochloride acid.

E3. The method of E1 or E2, further comprising receiving the copper cyanide solution in the precipitation tank from an elution vessel.

E4. The method of E3, further comprising contacting an activated carbon comprising copper with a solution of sodium hydroxide and sodium cyanide in the elution vessel to produce an eluate comprising the copper cyanide solution.

E5. The method of E4, wherein the activated carbon comprising copper further comprises gold and/or silver.

E6. The method of E5, wherein the solution of sodium hydroxide and sodium cyanide is at a pH ranging from about 11-12 and at a temperature ranging from about 0-60° C.

E7. The method of any one of E3-E6, further comprising receiving the solution of sodium hydroxide and sodium cyanide in the elution vessel from a recycle solution tank.

E8. The method of any one of E1-E7, further comprising receiving the gaseous effluent created in the precipitation tank in a gas scrubber.

E9. The method of E8, wherein the gaseous effluent is hydrogen cyanide gas.

E10. The method of E9, further comprising contacting the hydrogen cyanide gas in the gas scrubber with a sodium hydroxide solution to produce a sodium cyanide solution.

E11. The method of E10, further comprising removing the sodium cyanide solution from the gas scrubber.

E12. The method of any one of E1-E11, further comprising, optionally, contacting the solid copper cyanide with water in the production tank.

E13. The method of any one of E1-E12, wherein the solid copper cyanide is contacted with the sodium hydroxide solution in the production tank at ambient temperature.

E14. The method of any one of E1-E13, further comprising air sparging in the production tank.

E15. The method of any one of E1-E14, wherein the mole ratio of NaOH:CuCN in the production tank ranges from 2 to 0.1 (e.g., 1.9, 1.8, 1.7, 1.6, 1.5, 1.4, 1.3, 1.2, 1.1, 1, 0.9, 0.8, 0.7, 0.6, 0.5, 0.4, 0.3, 0.2), preferably 0.84 or greater.

E16. The method of any one of E1-E15, wherein the percent solids as CuCN ranges from 5% to 50% (e.g., 10%, 15%, 20%, 25%, 30%, 35%, 40%, 45%).

E17. The method of any one of E1-E16, wherein the dosage rate of NaOH in the production tank is at least 0.295 kg NaOH per kg of copper.

E18. The method of any one of E1-E17, wherein the dosage rate of NaOH in the production tank is at least 0.265 kg NaOH per kg of copper.

E19. The method of any one of E1-E18, wherein the copper oxide slurry comprises copper(I) oxide and/or copper(II) oxide.

E20. The method of E19, wherein 70% or greater (e.g., 75%, 80%, 85%, 90%) copper is recovered in the copper oxide.

E21. The method of any one of E8-E20, further comprising recycling any residual sodium hydroxide present in the second separation device back to the recycle solution tank, the gas scrubber, the production tank, or any combination thereof.

E22. A system for converting copper cyanide to copper oxide comprising:

a precipitation tank for contacting a copper cyanide solution with an acidic solution to produce a copper cyanide slurry;

optionally, the precipitation tank has a first output port for discharging the copper cyanide slurry;

optionally, the precipitation tank has a second output port for discharging a gaseous effluent created in the precipitation tank;

a first separation device for receiving the copper cyanide slurry and separating solid copper cyanide from the copper cyanide slurry;

optionally, the first separation device has a third output port for discharging the solid copper cyanide;

optionally, the first separation device has a fourth output port for discharging a liquid effluent created in the first separation device;

a production tank for receiving the solid copper cyanide and contacting the solid copper cyanide with a sodium hydroxide solution to produce a copper oxide slurry;

optionally, the production tank has a fifth output port for discharging the copper oxide slurry;

a second separation device for receiving the copper oxide slurry and separating solid copper oxide from the copper oxide slurry;

optionally, the second separation device has a sixth output port for discharging the solid copper oxide; and

optionally, the second separation device has a seventh output port for discharging any residual sodium hydroxide not reacted during the process of converting the solid copper cyanide to the copper oxide slurry in the production tank.

E23. The system of E22, wherein the precipitation tank has a first input port for receiving the copper cyanide solution and a second input port for receiving the acidic solution.

E24. The system of E22 or E23, wherein the acidic solution is selected from the group consisting of sulfuric acid, nitric acid, and hydrochloride acid.

E25. The system of any one of E22-E24, wherein the first input port for receiving the copper cyanide solution is connected to an elution vessel.

E26. The system of E25, wherein the elution vessel has a solid input port for receiving an activated carbon comprising copper and a liquid input port for receiving a solution of sodium hydroxide and sodium cyanide.

E27. The system of E26, wherein the activated carbon comprising copper further comprises gold and/or silver.

E28. The system of E27, wherein the activated carbon comprising copper is contacted with the solution of sodium hydroxide and sodium cyanide to produce an eluate comprising the copper cyanide solution.

E29. The system of E28, wherein the solution of sodium hydroxide and sodium cyanide is at a pH ranging from about 11-12 and at a temperature ranging from about 0-60° C.

E30. The system of any one of E22-E29, wherein the liquid input port for receiving the solution of sodium hydroxide and sodium cyanide is connected to a recycle solution tank containing the solution of sodium hydroxide and sodium cyanide.

E31. The system of any one of E22-E30, wherein the second output port of the precipitation tank is connected to a gas scrubber for receiving the gaseous effluent created in the precipitation tank.

E32. The system of E31, wherein the gaseous effluent is hydrogen cyanide gas.

E33. The system of E32, wherein the hydrogen cyanide gas in the gas scrubber is contacted with a sodium hydroxide solution to produce a sodium cyanide solution.

E34. The system of E33, wherein the gas scrubber has a liquid input port for receiving the sodium hydroxide solution and a liquid output port for removing the sodium cyanide solution.

E35. The system of any one of E22-E34, wherein the production tank for receiving the solid copper cyanide has a first liquid input port for receiving the sodium hydroxide solution and, optionally, a second liquid input port for receiving water.

E36. The system of any one of E22-E35, wherein the solid copper cyanide is contacted with the sodium hydroxide solution in the production tank at ambient temperature.

E37. The system of any one of E22-E35, wherein the solid copper cyanide is contacted with the sodium hydroxide solution in the production tank at about 40-50° C.

E38. The system of any one of E22-E37, further comprising air sparging in the production tank.

E39. The system of any one of E22-E38, wherein the mole ratio of NaOH:CuCN in the production tank ranges from 2 to 0.1 (e.g., 1.9, 1.8, 1.7, 1.6, 1.5, 1.4, 1.3, 1.2, 1.1, 1, 0.9, 0.8, 0.7, 0.6, 0.5, 0.4, 0.3, 0.2), preferably 0.84 or greater.

E40. The system of any one of E22-E39, wherein the percent solids as CuCN ranges from 5% to 50% (e.g., 10%, 15%, 20%, 25%, 30%, 35%, 40%, 45%).

E41. The system of any one of E22-E40, wherein the dosage rate of NaOH in the production tank is at least 0.295 kg NaOH per kg of copper.

E42. The system of any one of E22-E40, wherein the dosage rate of NaOH in the production tank is at least 0.265 kg NaOH per kg of copper.

E43. The system of any one of E22-E42, wherein the copper oxide slurry comprises copper(I) oxide and/or copper(II) oxide.

E44. The system of E22-E43, wherein 70% or greater (e.g., 75%, 80%, 85%, 90%) copper is recovered in the copper oxide.

E45. The system of any one of E31-E44, wherein any residual sodium hydroxide present in the second separation device is recycled back to the recycle solution tank, the gas scrubber, the production tank, or any combination thereof.

### REFERENCES

1. Botz, M and Acar, S (2007), “Copper precipitation and cyanide recovery pilot testing for the Newmont Yanacocha project”. SME Annual Meeting, Denver, Colo.
2. Dai, X, Simons, A and Breuer, P (2012), “A review of copper cyanide recovery technologies for the cyanidation of copper containing gold ores”. Minerals Engineering, Vol. 25, Issue 1, pp. 1-13
3. Dixon, S (2017), “Copper Prestrip to copper cyanide”, CIM Journal, Vol 1, No. 1, pp. 19-24.
4. Leaver, E. S., & Woolf, J. A. (1931). Copper and zinc in cyanidation sulphide-acid precipitation (Tech. Rep. No. 494). Washington, D.C.: USBM Technical Paper 494.
5. Lopez-Pancheco, A (2016), “Yanacocha's copper rush. SART plant optimization unlocks the future for the Newmont mine.” CIM Magazine, Vol. 11, No. 1, pp. 34-35.
6. Sceresini, B (1991), “Development and application of a process for the recovery of copper and complexed cyanide from cyanidation slurries” in Proceedings of Randol Gold Forum, Cairns, Australia.

1. A method for converting copper cyanide to copper oxide, comprising the steps of:
contacting a copper cyanide solution with an acidic solution in a precipitation tank under reaction conditions sufficient to produce a copper cyanide slurry;
removing the copper cyanide slurry from the precipitation tank;
optionally, removing a gaseous effluent created in the precipitation tank;
separating solid copper cyanide from the copper cyanide slurry in a first separation device;
removing the solid copper cyanide from the first separation device;
optionally, removing a liquid effluent created in the first separation device;
contacting the solid copper cyanide with a sodium hydroxide solution in a production tank under reaction conditions sufficient to produce a copper oxide slurry;
removing the copper oxide slurry from the production tank;
separating solid copper oxide from the copper oxide slurry in a second separation device;
optionally, removing the solid copper oxide from the second separation device; and
optionally, removing from the second separation device any residual sodium hydroxide not reacted during the process of contacting the solid copper cyanide with the sodium hydroxide solution in the production tank.

2. The method of claim 1, wherein the acidic solution is selected from the group consisting of sulfuric acid, nitric acid, and hydrochloride acid.

3. The method of claim 1, further comprising receiving the copper cyanide solution in the precipitation tank from an elution vessel.

4. The method of claim 3, further comprising contacting an activated carbon comprising copper with a solution of sodium hydroxide and sodium cyanide in the elution vessel to produce an eluate comprising the copper cyanide solution.

5. The method of claim 4, wherein the activated carbon comprising copper further comprises gold and/or silver.

6. The method of claim 5, wherein the solution of sodium hydroxide and sodium cyanide is at a pH ranging from about 11-12 and at a temperature ranging from about 0-60° C.

7. The method of claim 4, further comprising receiving the solution of sodium hydroxide and sodium cyanide in the elution vessel from a recycle solution tank.

8. The method of claim 1, further comprising receiving the gaseous effluent created in the precipitation tank in a gas scrubber.

9. The method of claim 8, wherein the gaseous effluent is hydrogen cyanide gas.

10. The method of claim 9, further comprising contacting the hydrogen cyanide gas in the gas scrubber with a sodium hydroxide solution to produce a sodium cyanide solution.

11. The method of claim 10, further comprising removing the sodium cyanide solution from the gas scrubber.

12. The method of claim 1, further comprising, optionally, contacting the solid copper cyanide with water in the production tank; or further comprising air sparging in the production tank.

13. The method of claim 1, wherein the solid copper cyanide is contacted with the sodium hydroxide solution in the production tank at ambient temperature.

14. (canceled)

15. The method of claim 1, wherein:
the mole ratio of NaOH:CuCN in the production tank ranges from 2 to 0.1; or
the percent solids as CuCN ranges from 5% to 50%; or
the dosage rate of NaOH in the production tank is at least 0.295 kg NaOH per kg of copper.

16. (canceled)

17. (canceled)

18. The method of claim 1, wherein the dosage rate of NaOH in the production tank is at least 0.265 kg NaOH per kg of copper.

19. The method of claim 1, wherein the copper oxide slurry comprises copper(I) oxide and/or copper(II) oxide.

20. The method of claim 19, wherein 70% or greater copper is recovered in the copper oxide.

21. The method of claim 8, further comprising recycling any residual sodium hydroxide present in the second separation device back to the recycle solution tank, the gas scrubber, the production tank, or any combination thereof.

22. A system for converting copper cyanide to copper oxide comprising:
a precipitation tank for contacting a copper cyanide solution with an acidic solution to produce a copper cyanide slurry;
optionally, the precipitation tank has a first output port for discharging the copper cyanide slurry;
optionally, the precipitation tank has a second output port for discharging a gaseous effluent created in the precipitation tank;
a first separation device for receiving the copper cyanide slurry and separating solid copper cyanide from the copper cyanide slurry;
optionally, the first separation device has a third output port for discharging the solid copper cyanide;
optionally, the first separation device has a fourth output port for discharging a liquid effluent created in the first separation device;
a production tank for receiving the solid copper cyanide and contacting the solid copper cyanide with a sodium hydroxide solution to produce a copper oxide slurry;
optionally, the production tank has a fifth output port for discharging the copper oxide slurry;
a second separation device for receiving the copper oxide slurry and separating solid copper oxide from the copper oxide slurry;
optionally, the second separation device has a sixth output port for discharging the solid copper oxide; and
optionally, the second separation device has a seventh output port for discharging any residual sodium hydroxide not reacted during the process of converting the solid copper cyanide to the copper oxide slurry in the production tank.

23. The system of claim 22, wherein the precipitation tank has a first input port for receiving the copper cyanide solution and a second input port for receiving the acidic solution.

24. The system of claim 22, wherein the acidic solution is selected from the group consisting of sulfuric acid, nitric acid, and hydrochloride acid.

25. The system of claim 22, wherein the first input port for receiving the copper cyanide solution is connected to an elution vessel.

26. The system of claim 25, wherein the elution vessel has a solid input port for receiving an activated carbon comprising copper and a liquid input port for receiving a solution of sodium hydroxide and sodium cyanide.

27. The system of claim 26, wherein the activated carbon comprising copper further comprises gold and/or silver.

28. The system of claim 27, wherein the activated carbon comprising copper is contacted with the solution of sodium hydroxide and sodium cyanide to produce an eluate comprising the copper cyanide solution.

29. The system of claim 28, wherein the solution of sodium hydroxide and sodium cyanide is at a pH ranging from about 11-12 and at a temperature ranging from about 0-60° C.

30. The system of claim 26, wherein the liquid input port for receiving the solution of sodium hydroxide and sodium cyanide is connected to a recycle solution tank containing the solution of sodium hydroxide and sodium cyanide.

31. The system of claim 22, wherein the second output port of the precipitation tank is connected to a gas scrubber for receiving the gaseous effluent created in the precipitation tank.

32. The system of claim 31, wherein the gaseous effluent is hydrogen cyanide gas.

33. The system of claim 32, wherein the hydrogen cyanide gas in the gas scrubber is contacted with a sodium hydroxide solution to produce a sodium cyanide solution.

34. The system of claim 33, wherein the gas scrubber has a liquid input port for receiving the sodium hydroxide solution and a liquid output port for removing the sodium cyanide solution.

35. The system of claim 22, wherein the production tank for receiving the solid copper cyanide has a first liquid input port for receiving the sodium hydroxide solution and, optionally, a second liquid input port for receiving water; or wherein the solid copper cyanide is contacted with the sodium hydroxide solution in the production tank at ambient temperature.

36. (canceled)

37. The system of claim 22, further comprising air sparging in the production tank.

38. The system of claim 22, wherein:
the mole ratio of NaOH:CuCN in the production tank ranges from 2 to 0.1; or
the percent solids as CuCN ranges from 5% to 50%; or
the dosage rate of NaOH in the production tank is at least 0.295 kg NaOH per kg of copper.

39. (canceled)

40. (canceled)

41. The system of claim 22, wherein the dosage rate of NaOH in the production tank is at least 0.265 kg NaOH per kg of copper.

42. The system of claim 22, wherein the copper oxide slurry comprises copper(I) oxide and/or copper(II) oxide.

43. The system of claim 42, wherein 70% or greater copper is recovered in the copper oxide.

44. The system of claim 31, wherein any residual sodium hydroxide present in the second separation device is recycled back to the recycle solution tank, the gas scrubber, the production tank, or any combination thereof.
